(19) United States
(12) Patent Application Publication
(10) Pub. No.: US 2001/0037214 A1
(43) Pub. Date: Nov. 1, 2001

(54) Method and system for controlling an employer's health care costs while enhancing an employee's health care benefits

(76) Inventors: Richard S. Raskin, Baldwin, NY (US); Allan M. Phillips, Short Hills, NJ (US); William Duncan Kane III, Highland Mills, NY (US)

Correspondence Address: Kramer Levin Naftalis & Frankel LLP, 919Third Avenue, New York, NY, 10022, US

(21) Appl. No.: 09/800,108

(22) Filed: Mar. 5, 2001

Related U.S. Application Data
(60) Provisional application No. 60/246,204, filed on Nov. 6, 2000.

(51) Int. Cl. G06F 17/60

(52) U.S. Cl. 705/2

(57) ABSTRACT

A method and system that incentivizes an employee to forego coverage under one or more health care plans maintained by the employee's employer (the “Sponsoring Employer”). According to the method and system, an employee eligible for health care coverage under another plan or plans not sponsored by the Sponsoring Employer is given the option to elect between coverage under (a) a reimbursement account or plan maintained by the Sponsoring Employer that covers eligible health care expenses not covered under such other plan or plans (including, but not necessarily limited to, deductibles, coinsurance and co-payments) and (b) the Sponsoring Employer's other health care plan or plans. The reimbursement account or plan is offered as an inducement to the employee to waive coverage under some or all of the Sponsoring Employer's other health care plan or plans and elect coverage under such other plan or plans not sponsored by the Sponsoring Employer, which is most typically a plan sponsored by the employer of the employee's spouse.

### RELATED APPLICATIONS

This Application claims priority from previously filed U.S. Provisional Application No. 60/246,204 filed Nov. 6, 2000, which is hereby incorporated by reference in its entirety.

### BACKGROUND OF THE INVENTION

The present invention is generally directed to a method (and system) that incentivizes an employee to forego coverage under one or more health care plans (a “Sponsor's Health Plan or Plans”) maintained by the employee's employer (the “Sponsoring Employer”). More particularly, an employee eligible for health care coverage under another plan or plans not sponsored by the Sponsoring Employer (an “Alternate Plan”) is given the option to elect between coverage under the Sponsor's Health Plan or Plans and a reimbursement account or plan maintained by the Sponsoring Employer (a “Sponsor's Reimbursement Account”) that covers eligible health care expenses not covered under the Alternate Plan (including, but not necessarily limited to, deductibles, coinsurance and co-payments). The Sponsor's Reimbursement Account is offered as an inducement to the employee to waive coverage under some or all of the Sponsor's Health Plan or Plans and elect coverage under the Alternate Plan, which is most typically a plan sponsored by the employer of the employee's spouse.

Health care costs have dramatically escalated in the United States and, indeed, around the world. In an effort to contain these escalating costs, employers have looked for ways to provide health care coverage to their employees while keeping their costs to a minimum. However, employers have found health care costs are not easily managed since these costs may rise unexpectedly for any number of reasons beyond their control. As a result, employers have sought alternatives to providing employees with health care coverage, including shifting the expense of health care costs to the employees or other employers. The first of these approaches, by its nature, requires employees to pay for a greater share of the health care cost; the second frequently does.

Among these approaches is the direct or indirect payment of cash to employees who waive coverage under the Sponsor's Health Plan or Plans. However, while cash payouts offer an employee the incentive to waive coverage under the Sponsor's Health Plan or Plans, the incentive may be significantly reduced by the fact that cash payout is subject to applicable federal and state income taxes. In addition, such cash incentives are not health care plans, and as such do not give the employee the right—which is available under health care reimbursement accounts or plans—to continue to receive such payments following termination of employment under the Federal law known as “COBRA.” Cash payouts accordingly provide a lesser incentive to the employee for the desired waivers than a reimbursement account or plan, and are correspondingly less useful to the employer in achieving its objective of controlling health care costs. Cash payments also are less cost-efficient than medical reimbursement accounts, because they may be made to employees who otherwise would receive little or no reimbursement on account of health care, and thus more expensive for the employer.

Also known are plans under which an employer establishes a health care reimbursement account or plan to reimburse for health care expenses of an employee and his or her family that are not covered under any other plan, whether of the Sponsoring Employer, an employer of the employee's spouse or other family member, or any other insurance or plan. While some of these reimbursement accounts or plans are funded by the employer, the great majority (commonly known as health care flexible spending accounts) are funded exclusively by the employee's election to reduce pay in accordance with the rules of Section 125 of the Internal Revenue Code, relating to so-called “cafeteria” plans (“Section 125 Cafeteria Plans”). Section 125 of the Internal Revenue Code allows an employee to elect to receive nontaxable health or other benefits in lieu of cash compensation, without being taxed (under the “constructive receipt” doctrine) on the cash that the employee could have received—thus allowing the employee's share of the cost of those benefits to be paid for by “pre-tax contributions,” rather than contributions out of pay already subject to tax (“after-tax contributions”).

However, irrespective of the source of funding, no plan (or other inducement to elect a lower cost alternative) is known in which the availability of a medical reimbursement account or plan used to cover eligible health care expenses not reimbursed by an Alternate Plan is expressly conditioned on the employee's choosing coverage under the Alternate Plan. The availability of such a reimbursement account or plan enhances the appeal to the employee of the alternative that the Sponsoring Employer is trying to induce the employee to choose in preference to its own health care plans (e.g., by overcoming the common kinds of limitations on Alternate Plan coverage by reimbursing for deductibles, co-insurance, and co-pays, and possibly other payments not covered by the Alternate Plan, including medical care received out-of-network or out-of-HMO). Similarly, the payment of benefits only to those who incur health care claims enhances the appeal to the Sponsoring Employer, as it knows benefit payments are being made only to those who would have potential claims against the Sponsor's Health Plan or Plans.

### SUMMARY OF THE INVENTION

The present invention is generally directed to a method (and system) of reducing an employer's health care costs including the steps of providing an employee with the option to elect between a Sponsor's Health Plan or Plans and a Sponsor's Reimbursement Account to the exclusion of the other, receiving an election from an employee for coverage under the Sponsor's Reimbursement Account, and processing the employee's claims for reimbursement under the Sponsor's Reimbursement Account.

In one aspect of the present invention, the Sponsor's Reimbursement Account is fully funded by the Sponsoring Employer and offered to the employee as an inducement to waive available coverage under the Sponsor's Health Plan or Plans. In another aspect, the Sponsor's Reimbursement Account is basically funded by the Sponsoring Employer and offered to the employee as such an inducement, but the amount available for reimbursement under the Sponsor's Reimbursement Account may be increased if the employee funds the increase in whole or in part by agreeing to reduce his cash compensation. In a further variation of either of the above, the level of reimbursements available for the Sponsor's Reimbursement Account will vary depending upon the extent to which the employee foregoes other plan coverages available from the Sponsoring Employer. In a still further variation of either of the above, the level of reimbursements available for the Sponsor's Reimbursement Account will vary depending upon other criteria established by the sponsoring employer (e.g. family status or health habits). In each case, benefits under the Sponsor's Reimbursement Account may be provided either by direct payments by the Sponsoring Employer, or through other means such as trust or other entity, tax-exempt or otherwise, or an insurance policy, or any combination thereof, at the discretion of the Sponsoring Employer.

In each of the above aspects of the present invention, a system for managing an employee's election and claims for reimbursement under the Sponsor's Reimbursement Account is provided, including a processor, a database for storing employees' election and claim reimbursement information, and a means for processing employees' reimbursement claims.

It is still a further aspect of the present invention to provide such a health care reimbursement account or plan which may be used by an employer as an incentive for an employee to waive coverage for a spouse and/or other eligible family member under one or more of the Sponsoring Employer's health care plans.

Accordingly, it is an object of the present invention to shift the cost of health care to another entity by making available to employees a health care reimbursement account or plan that incentivizes employees to opt-out of an employer's health care coverage in favor of alternative coverage available under another plan, without the incentive being subject to income taxes which diminish its effectiveness. The tax-favored treatment of the invention is available because, under Sections 105 and 106 of the Internal Revenue Code, neither the establishment of a Sponsor's Reimbursement Account, nor payment of benefits thereunder, is taxable to the employee. The employee may opt out of his employer's health care coverage in favor of such alternative coverage for the employee alone or (as will frequently be the case where the alternative coverage is under a plan of the spouse's employer), for the employee and his spouse and/or dependents (or domestic partner).

It is another object of the present invention to structure the health care reimbursement account or plan so as to increase the attractiveness of that alternative coverage. The employee participating in a Sponsor's Reimbursement Account can receive tax-free, up to the limit fixed by the Sponsoring Employer, reimbursement of “out-of-pocket” health care costs that are not otherwise covered by an Alternate Plan, including coinsurance amounts, deductibles and copayments.

It is still a further object of the present invention to structure the health care reimbursement account or plan so as to increase the attractiveness to the Sponsoring Employer by limiting the expenses reimbursed out of that account or plan to coinsurance amounts, deductibles, co-payments and the like under the Alternate Plan with respect to situations in which benefits would have been paid for the type of care involved had the employee been covered under the Sponsor's Health Plan or Plans.

Still other objects and advantages of the invention will in part be obvious and will in part be apparent from the specification.

The invention accordingly comprises the several steps and the relation of one or more of such steps with respect to each of the others, and the system embodying features of construction, combination of elements and arrangement of parts, which are adapted to effect such steps, all as exemplified in the following detailed disclosure.

### BRIEF DESCRIPTION OF THE DRAWINGS

For a fuller understanding of the invention, reference is had to the following description taken in connection with the accompanying drawings, in which:

FIG. 1 is a diagram of a system for recording a benefit election and processing reimbursement claims according to an exemplary embodiment of the present invention;

FIG. 2 is a flow diagram for receiving and recording an employee's election to participate under the Reimbursement Plan according to an exemplary embodiment of the present invention; and

FIG. 3 is a flow diagram of a claim reimbursement process according to an exemplary embodiment of the present invention.

### DESCRIPTION OF THE EXEMPLARY EMBODIMENT

For purposes of this disclosure, it should be understood that health care plans may include medical plans, dental plans, prescription drug plans, vision plans, mental health plans, and any other plans reimbursing health care expenses within the meaning of Sections 105 and/or 106 of the Internal Revenue Code. The Sponsor's Health Plan or Plans, any Alternate Plan, and the Sponsor's Reimbursement Account offered by the Sponsoring Employer, as those terms are used in this disclosure, are all health care plans within the meaning of Sections 105 and 106, with the result that employer contributions to provide plan coverage are generally free of income tax, as are the reimbursements of expenses provided under those plans.

Because of the increased attractiveness of a plan in which all costs are paid for by “employer contributions,” and thus tax-free under Sections 105 and 106, plans that charge an employee for a portion of the cost of coverage are generally structured as part of a Section 125 Cafeteria Plan, in which the employee's contribution is made by an election to reduce otherwise taxable compensation and is treated as a “pre-tax” contribution. The Sponsor's Health Plan or Plans, and Alternate Plan offered by another employer, will usually be part of a Section 125 Cafeteria Plan. The Sponsor's Reimbursement Account that is the heart of the present invention need not be part of a Section 125 Cafeteria Plan where it is funded by the employer, but may, nevertheless be part of a Section 125 Cafeteria Plan as a result of its relationship to other plans offered by the sponsoring employer.

Health care plans, whether the Sponsor's Health Plan or Plans or an Alternate Plan, may be insured or uninsured, funded or unfunded, or a combination thereof. Any of such plans may be noncontributory or contributory (meaning that the employees are required to make pre-tax and/or after-tax contributions as a condition of coverage). The coverage provided under any of such plans may be either traditional indemnity coverage, meaning that benefits are reimbursed without distinctions based on whether the healthcare provider is part of a network; or a point-of-service plan or preferred provider plan, in which participants may obtain coverage within or outside of a network, with the latter involving increased costs to be borne by the employee that are not imposed for in-network coverage; or an HMO or EPO, in which participants may obtain coverage solely within a network. Other health care plan configurations are possible, as known to those skilled in the art, including plans that include a Medicare or other government component.

The present invention is directed to a Sponsor's Reimbursement Account that is offered as an inducement to the employee to forego coverage under some or all of the Sponsor's Health Plan or Plans and elect coverage under an Alternate Plan. The Alternate Plan may be any plan not sponsored by the Sponsoring Employer, including another employer's plan; Medicare, Champus, or any other government plan; a student plan, or private insurance plan. In the most common scenario, another employer such as a spouse's employer sponsors the Alternate Plan. However, the other employer may be the employer of another family member or of the employee's domestic partner, or a former employer of the employee.

The present invention is specifically designed to maximize the attractiveness to the employee of electing the Sponsor's Reimbursement Account in lieu of a Sponsor's Health Plan or Plans by eliminating shortcomings or disadvantages of the Alternate Plan. The Sponsor's Reimbursement Account will be designed to cover health care expenses of an employee (or his family member or domestic partner) who has elected to participate in an Alternate Plan but which are not covered by the Alternate Plan, (which is an exemplary embodiment is a health care plan sponsored by another employer).

If the Alternate Plan is an indemnity plan, the traditional but increasingly less common form of health care plan, it requires the employee and/or other family members and/or domestic partner to pay significant costs for deductibles and coinsurance. If the Alternate Plan is a point of service plan or a preferred provider plan, the employee and/or other family members and/or domestic partner may be required to bear costs for co-pays, deductibles and coinsurance even for in-network coverage, and to pay significantly increased costs for deductibles and co-insurance when going out-of-network. In all of the above cases, the Sponsor's Reimbursement Account is offered as the “opt out” incentive that reimburses those costs on a tax-free basis (since reimbursement of health expenses to an employee is tax-free under Section 105 of the Internal Revenue Code), thus enhancing the value and attractiveness of the Alternate Plan and encouraging the opt-out.

If the other employer offers an HMO, or the employee and/or other family members and/or domestic partner elect an HMO option because it is cheapest, the Sponsor's Reimbursement Account makes it possible for them to be reimbursed for any required co-pays and, at the Sponsoring Employer's discretion, may make it possible for them to see physicians and use services not provided by the HMO where that is necessary or desired, without their having to bear the costs of non-HMO service they would otherwise bear, thus making the other employer's HMO a much more attractive alternative plan option than it would otherwise be.

Reimbursable expenses are not limited to co-pays, co-insurance and deductibles, but, at the Sponsoring Employer's discretion, may include any expense that qualifies as a health expense under Section 213 of the Internal Revenue Code. Eligible expenses may include, but are not limited to, one or more of following: (i) the Alternate Plan's deductibles; (ii) the Alternate Plan's coinsurance; (iii) the Alternate Plan's co-payments; (iv) expenses not covered by the Alternate Plan; (v) the level fixed as expenses in excess of the Alternate Plan's limits, (vi) proper expenses determined to be in excess of the reasonable and customary benchmark used by the Alternate Plan, and (vii) in each such case, expenses from more than one Alternate Plan.

According to the present invention, it is wholly within the Sponsoring Employer's discretion to fix the amount reimbursable, determine whether that amount may be increased by an employee's election to supplement the employer funding of the Sponsor's Reimbursement Account by a Section 125 Cafeteria Plan election to reduce his cash compensation, to determine the eligible claims that will be honored under the Sponsor's Reimbursement Account, and to vary any of the above by class of employee. Typically, all of these terms are established before the employee elects to participate in the Sponsor's Reimbursement Account and to waive coverage under one or more Sponsor Health Plans. An employer may have more than one type of Sponsor's Reimbursement Account that is offered as an incentive to employees to waive coverage under the Sponsor's Health Plan or Plans.

According to an exemplary embodiment of the present invention, the Sponsor's Reimbursement Account that is offered to the employee as an inducement to reject the Sponsor's Health Plan or Plans is an unfunded plan, benefits under which are paid directly by the Sponsoring Employer. However, it is possible for the Sponsor's Reimbursement Account to be funded through a trust or other entity, or through an insurance policy or the like.

In another embodiment, some cash in addition to the Sponsor's Reimbursement Account would be offered, either as alternatives, or together, as the inducement to forego the Sponsor's Health Plan or Plans. Still other variants are possible and known to those skilled in the art, given the particular health care plan configurations in place, under which the Sponsor's Reimbursement Account would or would not qualify as part of a Section 125 Cafeteria Plan.

In an alternative exemplary embodiment of the present invention, the Sponsor's Reimbursement Account may be offered as an inducement to the employee to forego coverage under one or more of the Sponsor's Health Plans but not all. It may be a common embodiment for the Sponsor's Reimbursement Account to be conditioned on opting out of all of the Sponsor's Health Plans that reimburse for medical benefits, but to allow the employee to elect both the Sponsor's Reimbursement Account and coverage under Sponsor's Health Plans that are limited to (say) dental benefits or vision care or the like, including a health care flexible spending account not conditional on opting out of coverage.

Alternatively, the Sponsor's Reimbursement Account may be offered as an inducement to an employee to decline coverage of the employee's family or domestic partner under the Sponsor's Health Plan or Plans; that is, the employee is induced to cover his or her family or domestic partner under an Alternate Plan, enhanced by a Sponsor's Reimbursement Account that reimburses eligible expenses not covered under the Alternate Plan.

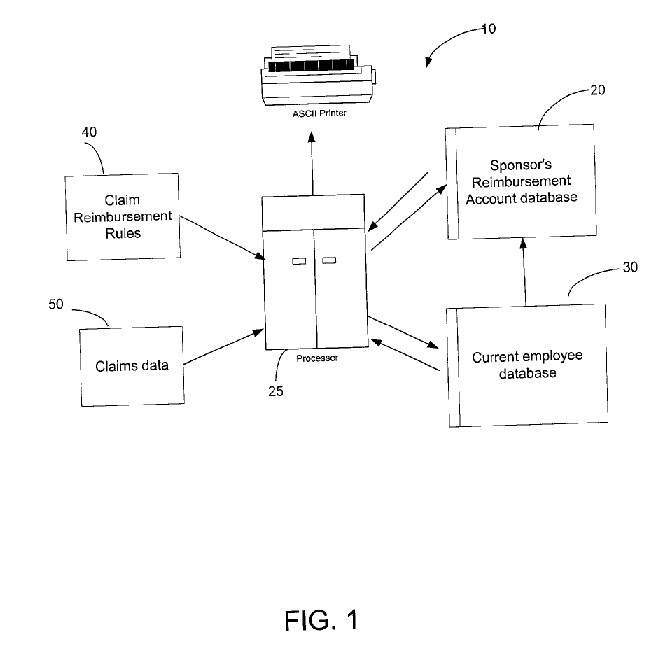

Referring to FIG. 1, an exemplary computer system 10 that may be employed for administrating the present invention is disclosed. Of course, it should be noted that the method of the present invention, namely, incentivizing an employee to forego coverage under one or more of the Sponsor's Health Plans in favor of an Alternate Plan and by offering a Sponsor's Reimbursement Account as described herein may be implemented and administered by employers, third party administrators or insurance companies using their existing benefit election/administration systems.

The system 10 processes all elections by employees to waive coverage under one or more of the Sponsor's Health Plans in favor of an Alternate Plan and the Sponsor's Reimbursement Account. The computer system 10 may comprise any number of commercially available hardware and software components, such as keyboards, monitors, printers, operating systems, spreadsheet and accounting software.

As shown in FIG. 1, the system 10 according to an exemplary embodiment may be operated by a conventional computer system having a processor 25 for running one or more software programs for managing employee elections and the reimbursement of claims under the Sponsor's Reimbursement Account. The system 10 may include a current employee database 30 and Sponsor's Reimbursement Account database 20. Alternatively, as is well known, the current employee database 30 and Sponsor's Reimbursement account database 20 may be merged in a single database. As will be explained herein, the Sponsor's Reimbursement Account database maintains a record for each employee who has opted for coverage under the Sponsor's Reimbursement Account. For each employee record, the database 20 includes various data fields for storing relevant information concerning an employee's election and claims under the Sponsor's Reimbursement Account.

As further shown in FIG. 1, the processor 25 receives as input data a set of rules 40 for reconciliation of employees' reimbursement claims under the Sponsor's Reimbursement Account. The claim rules 40 determine reimbursable expenses, reimbursement timing, annual reimbursement limits, dependent eligibility and other process parameters. To process claims, the system 10 also accepts specific data concerning employees' reimbursement claims 50 (e.g., claim amount, date of claim, service provider). The complexity of the system 10 and its rules 40 will depend on the types of health care plans in place and the obligations of the Sponsoring Employer and participating employee under the Sponsor's Reimbursement Account.

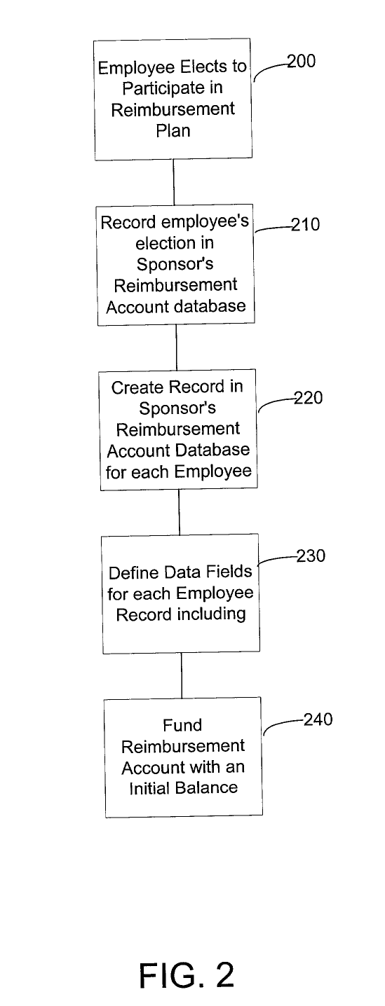

Referring now to FIG. 2, a process flow is shown for receiving and recording an employee's election to participate in the Sponsor's Reimbursement Account. In a first step 200, an employee elects to participate in the Sponsor's Reimbursement Account. Of course, as part of this election, the employee has waived coverage under the Sponsor's Health Plan or Plans in favor of Alternate Coverage. In steps 210 and 220, the employee's election to participate is recorded in the Reimbursement Plan database and a record for the employee is created. In step 230, the data fields “Current Year Amount Available,”“Previous Year Amount Available,” and “Check To Be Written” are defined for each employee record. Next, in step 240, an initial balance for each employee's account is set up in the “Current Year Amount Available” data field. Initially, this data field is examined by the system 10 to determine if there are sufficient funds to reimburse an employee's claim. At the end of a plan year, the funds remaining for the current year, if any, are transferred to the “Previous Year Amount Available” to honor claims filed after the plan year provided the claim is filed within X number of weeks, as specified in the claim rules 40.

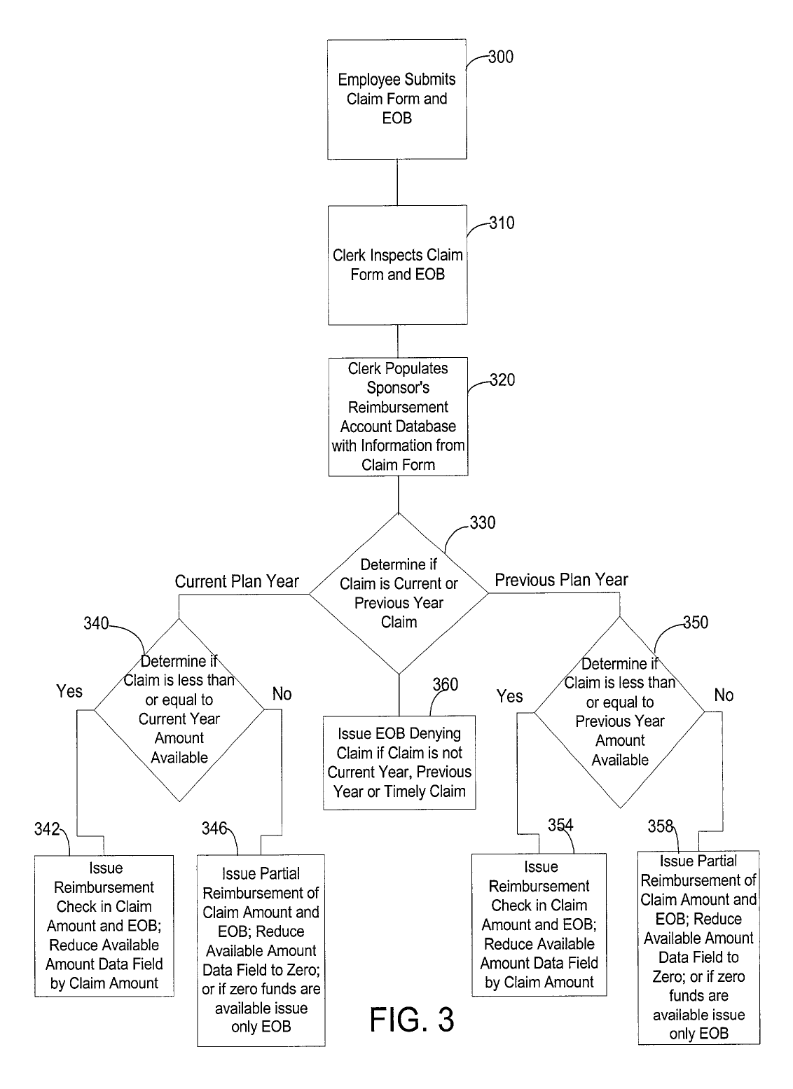

FIG. 3 depicts a flow for processing claims for reimbursement under the Sponsor's Reimbursement Account. In step 300, the employee submits a claim form and EOB (Explanation of Benefits or other evidence of claim denial or limitation) provided by the Alternate Plan administrator or carrier (e.g., administrator of the health plan of the spouse's employer) to an administrator appointed by the Sponsoring Employer (and who may be an employee or an independent third party administrator) to handle claims. The administrator reviews the claim form and EOB for compliance with the established claim rules in step 310. The claim form and EOB may be mailed or faxed to the administrator. The administrator may scan the claim and EOB to create an electronic record of the documents.

In step 320 the administrator populates the database 20 with at least the following data points taken from the claim form and EOB: (i) the identity of the person for whom services were performed (e.g., employee, employee's qualified family member); (ii) date services were performed; (iii) the provider of services (e.g., doctor, hospital); and (iv) the amount of the claim. Each of these data points is preferably a data field in the database 20. Upon the initial inspection by the administrator, the administrator may also set a field in the database 20 indicating whether the claim is reimbursable in accordance with the established claim reimbursement rules. If the administrator indicates that the claim is not reimbursable, then an EOB will be generated denying coverage. All other processing steps are bypassed. The EOB Message may read: “This claim is not for reimbursable expenses.” It should be noted that although the administrator can apply the claim rules, this may be a fully automated process by programming the system 10 to determine if a particular claim qualifies as a reimbursable expense under the established claim rules 40.

In an exemplary embodiment, after populating the database, the system 10 checks for duplicate submissions based on the date entered above. If the claim is a duplicate, data for an EOB is generated and the EOB is printed. A typical EOB message may read: “This is a duplicate claim.”

Next, in step 330, the administrator performs an initial review to determine if the claim is for the current year or previous year. If the claim is for the current year and a reimbursable expense, as verified in steps 310 and 320, the system 10 checks the claim amount against the amount available for the current year in step 340. If the verified claim is less than or equal to the amount available for the current year, then the claim is honored and a check is issued. As part of this process the claim amount is added to the “Check To Be Written” data field in database 20. The system 10 reads the amount in the “Check To Be Written” data field and generates a check in this amount. At the same time, data for an EOB is generated for printing with the check, and the amount available for the current year, as indicated in the “Current Year Amount Available” data field, is reduced by the claim amount.

If the verified claim is greater than the amount available for the current year, then the total amount identified in the “Current Year Amount Available” data field is added to the “Check To Be Written” field and data for an EOB is generated for printing with the check. The “Current Year Amount Available” is reduced to zero and an EOB message is written indicating that there were insufficient funds to cover the full claim amount. For example, the EOB message may read: “This claim was reduced because it exceeded the amount available in your account.” In the event there are no funds available (i.e., the “Current Year Amount Available” is zero), then only data for an EOB is generated and the EOB is printed. In this case, the EOB message may read: “This claim was not paid because the amount available in your account is zero.”

As shown in FIG. 3, in step 330, if the claim date is within a previous plan year, then in step 350 a determination is made by the system 10 whether the claim is less than or equal to the previous year amount. In making this determination, the system 10 looks to a “Previous Year Amount Available” data field. If the claim amount is less than or equal to the “Previous Year Amount Available,” then a reimbursement is issued. As part of this process, the claim amount is added to the “Check To Be Written” data field, data for an EOB is generated for printing with the check and the “Previous Year Amount Available” is reduced by the claim amount.

If the verified claim is greater than a non-zero “Previous Year Amount Available,” then the “Current Year Amount Available” is added to the “Check To Be Written” field and data for an EOB is generated for printing with the check. The “Previous Year Amount Available” is reduced to zero. The EOB message may read: “This claim was reduced because it exceeded the amount available in your account.” If the “Previous Year Amount Available” is zero, then only data for an EOB is generated and the EOB is printed. In this case, the EOB Message may read: “This claim was not paid because the amount available in your account is zero.”

In step 360, if the system determines that the claim date is not within the current plan year or the previous plan year, data for an EOB is generated and the EOB is printed. All other processing steps are bypassed. In this case an EOB Message may read: “This claim is too old to process.” The system 10 also checks in step 360 to determine if the current date is beyond the filing deadline. If it is, data for an EOB is generated and an EOB is printed. All other processing steps are bypassed. In such event, the EOB message may read: “This claim was not submitted on time.”

In another aspect of an exemplary embodiment, the system 10 periodically generates checks for all non-zero “Check To Be Written” fields and prints related EOB's. All such “Check To Be Written” fields are reset to zero after the check is written. Checks written are stored with the employee record (check number, check date, check amount). The system 10 generates an employer sorted check register and summary and employers are contacted to fund the checking account. Once the account is funded, checks and EOB's are mailed to the employee's home address. On the last day of the plan year, the “Current Year Amount Available” is transferred to the “Previous Year Amount Available.” At some employer elected date, all non-zero “Previous Year Amount Available” fields are reduced to zero.

Thus, under the proposed system and method there is a more efficient allocation of the Sponsoring Employer's benefit dollars since the Sponsoring Employer is offering an alternative to the Sponsor's Health Plan or Plans that takes advantage of the fact that the employee and or his family may be eligible under another plan (e.g., a health plan of the spouse's employer). By providing the employee the option tax-free reimbursement for health related expenses not covered by that alternative plan, an incentive is created for the employee to opt-out of an employer's medical coverage in favor of alternative coverage available under (for example) the spouse's plan.

It will thus be seen that the objects set forth above, among those made apparent from the preceding description, are efficiently attained and, since certain changes may be made in carrying out the above method and in the system set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

What is claimed is:

1. A method for an employer of at least one employee to control health care costs comprising the steps of offering an employee the choice between (a) a plan or account sponsored by the employer that reimburses for eligible health care expenses and (b) the employer's other health care coverage, and conditioning the availability of said plan or account on the employee declining at least in part said employer's other health care coverage for at least one of himself and another individual eligible to participate under said employer's other health care coverage and electing coverage for at least one of himself and said other eligible individual under an alternate health care plan.

2. The method of claim 1 wherein said other eligible individual comprises at least one of the employee's spouse, the employee's children, the employee's dependents and the employee's domestic partner.

3. The method of claim 1 wherein the employee declines all of said employer's other health care coverage for himself and said other eligible individual and the alternate health care plan is sponsored by at least one of an employer of the employee's spouse, an employer of another family member of the employee and an employer of a domestic partner of the employee.

4. The method of claim I wherein the employee declines all of said employer's other health care coverage for himself and said other eligible individual and the alternate health care plan is sponsored by at least one of the employee's former employer, a former employer of the employee's spouse, a former employer of another family member of the employee and a former employer of a domestic partner of the employee.

5. The method of claim I wherein the employee declines all of said employer's other health care coverage for himself and said other eligible individual and said alternate health care plan is at least one of a government plan, a student plan and private insurance.

6. The method of claim 5 wherein said government plan comprises at least one of Medicare and Champus.

7. The method of claim I wherein said plan or account is used to reimburse eligible health care expenses consisting of deductibles, co-payments and coinsurance amounts required by said alternate health care plan.

8. The method of claim 1 wherein the employee declines all of said employer's other health care coverage for himself and said other eligible individual, and said plan or account is used to reimburse eligible expenses not covered under said alternate health care plan.

9. The method of claim 1 wherein said employer's other health care coverage includes a dental care plan and the employee declines all of said employer's other health care coverage for himself and said other eligible individual except the dental care plan.

10. The method of claim 8 wherein said plan or account is used to reimburse eligible expenses not covered under said alternate health care plan and eligible expenses related to dental care not covered by the dental care plan.

11. The method of claim 1 wherein said employer's other health care coverage includes a vision care plan and the employee declines all of said employer's other health care coverage for himself and said other eligible individual except the vision care plan.

12. The method of claim 10 wherein said plan or account is used to reimburse eligible expenses not covered under said alternate health care plan and eligible expenses related to vision care not covered by the vision care plan.

13. The method of claim 1 wherein said employer's other health care coverage includes a health care flexible spending account.

14. The method of claim 1 wherein reimbursement claims under said plan or account are wholly funded by the employer.

15. The method of claim 1 wherein reimbursement claims under said plan or account are funded by the employer and the employee's pre-tax-contributions.

16. The method of claim 1 wherein reimbursement claims under said plan or account are paid by at least one of the employer, an insurance policy and a trust.

17. The method of claim 1 comprising the further step of imposing an annual limit on the amount of eligible health care expenses reimbursable under said plan or account.

18. The method of claim 1 comprising the further step of varying the imposed annual limit on the amount of eligible health care expenses reimbursable under said plan or account separately as to one or more of the employee and said other eligible individual under said plan or account.

19. The method of claim 1 comprising the further step of varying the imposed annual limit on the amount of eligible health care expenses reimbursable under said plan or account depending upon the extent to which the employee foregoes coverage available under said employer's other health care coverage.

20. The method of claim 1 comprising the further step of varying the imposed annual limit on the amount of eligible health care expenses reimbursable under said plan or account depending upon other criteria established by the employer.

21. The method of claim 19 wherein said other criteria include at least one of the employee's family status and the employee's health habits.

22. A method of reducing an employer's health care costs comprising the steps of providing an employee with the option to elect between an employer sponsored health care expense reimbursement plan or account and the employer's other sponsored health care coverage, conditioning the availability of said reimbursement plan or account on the employee declining said employer's other sponsored health care coverage and electing coverage under an alternate health care plan, and reimbursing the employee for eligible health care expenses not reimbursed under said alternate health care plan.

23. The method of claim 22 wherein said alternate health care plan is at least one of another employer's health care plan, government plan, student plan and private insurance plan.

24. The method of claim 22 wherein the employee elects said reimbursement plan or account and said alternate health care plan is sponsored by at least one of an employer of the employee's spouse, an employer of another family member of the employee and an employer of a domestic partner of the employee.

25. The method of claim 22 wherein the employee elects said reimbursement plan or account and said alternate health care plan is sponsored by at least one of the employee's former employer, a former employer of the employee's spouse, a former employer of another family member of the employee and a former employer of a domestic partner of the employee.

26. The method of claim 22 wherein said reimbursement plan or account is used to reimburse eligible health care expenses consisting of deductibles, co-payments and coinsurance amounts required by said alternate health care plan.

27. The method of claim 22 wherein reimbursement claims under said reimbursement plan or account are wholly funded by the employer.

28. The method of claim 22 wherein reimbursement claims under said reimbursement plan or account are funded by the employer and the employee's pre-tax contributions.

29. The method of claim 22 wherein reimbursement claims under said reimbursement plan or account are paid by at least one of the employer, a trust and an insurance policy.

30. The method of claim 22 comprising the further step of imposing an annual limit on the amount of eligible health care expenses reimbursable under said reimbursement plan or account.

31. The method of claim 22 comprising the further step of varying the imposed annual limit on the amount of eligible health care expenses reimbursable under said reimbursement plan or account separately as to one or more of the employee and said other eligible individual under said reimbursement plan or account.

32. The method of claim 22 comprising the further step of varying the imposed annual limit on the amount of eligible health care expenses reimbursable under said reimbursement plan or account depending upon the extent to which the employee foregoes coverage available under said employer's other health care coverage.

33. The method of claim 22 comprising the further step of varying the imposed annual limit on the amount of eligible health care expenses reimbursable under said reimbursement plan or account depending upon other criteria established by the employer.

34. The method of claim 33 wherein said other criteria include at least one of the employee's family status and the employee's health habits.

35. The method of claim 22 wherein the election of and reimbursement of claims under said reimbursement plan or account are administered by at least one of the employer, an insurance company and an outside third party administrator.

36. An employee health care administration system comprising means for storing the employee's election of coverage under a plan or account sponsored by an employer that reimburses eligible health care expenses, a database for storing a record of the employee's activity under the plan or account, means for storing the plan or account administration rules including an administrative rule defining at least one of eligible reimbursable expenses, reimbursement timing and annual reimbursement limits, and means responsive to the plan or account administration rules for processing the employee's reimbursement claims under the plan or account to the exclusion of the employee's reimbursement claims under at least some of the employer's other health care coverage for at least one of the employee and the employee's family.

37. The system of claim 36 wherein the health care administration system includes means for generating reimbursement checks and EOBs.
